(19) United States
(12) Patent Application Publication
(10) Pub. No.: US 2025/0276600 A1
(43) Pub. Date: Sep. 4, 2025

(54) CHARGING-AND-DISCHARGING SYSTEM FOR SELECTIVELY PERFORMING CHARGING OR DISCHARGING OF ELECTRIC VEHICLE BY CHARGING-AND-DISCHARGING VOLTAGE CONTROL AND CHARGING-AND-DISCHARGING CONTROL METHOD USING SAME

(71) Applicant: KOREASIMULATOR CO., LTD., Gyeonggi-do (KR)

(72) Inventor: Hyungtae KIM, Gyeonggi-do (KR)

(21) Appl. No.: 19/212,716

(22) Filed: May 20, 2025

Related U.S. Application Data
(63) Continuation of application No. PCT/KR2022/018666, filed on Nov. 24, 2022.

(30) Foreign Application Priority Data
Nov. 22, 2022 (KR) 10-2022-0157732

(51) Int. Cl. B60L 53/62; H02J 7/00

(52) U.S. Cl. CPC B60L 53/62; H02J 7/00308; H02J 7/007182; B60L 2240/547; B60L 2240/549

(57) ABSTRACT

The technical concept of the present disclosure relates to a charging-and-discharging system for selectively performing charging or discharging of electric vehicles by charging-and-discharging voltage control, and a charging-and-discharging control method using the same. In an embodiment, a charging-and-discharging control method of a charging-and-discharging system for performing charging-and-discharging of a battery of an electric vehicle according to the technical concept of the present disclosure may include: receiving a discharging command; increasing a charging-and-discharging voltage to a first voltage corresponding to a voltage level of the battery; supplying a test current using a current cutoff circuit; closing a relay switch with the electric vehicle in response to a confirmation signal for the test current; and decreasing the charging-and-discharging voltage to a second voltage lower than the first voltage.

### CROSS-REFERENCE TO RELATED APPLICATION

This application is a US Bypass Continuation Application of International Application No. PCT/KR2022/018666, filed on Nov. 24, 2022, which claims priority to and the benefit of Korean Patent Application No. 10-2022-0157732, filed on Nov. 22, 2022, the disclosure of which is incorporated herein by reference in its entirety.

### BACKGROUND

### Technical Field

The present invention relates to a charging-and-discharging system, and more particularly, to a charging-and-discharging system for selectively performing charging or discharging of electric vehicles by charging-and-discharging voltage control, and a charging-and-discharging control method using the same.

### Background Art

Recently, due to the surge in carbon emissions from internal combustion engine vehicles, air pollution has become serious, and there is growing interest in technological approaches to promote the adoption of electric vehicles for mitigation. Plug-in Electric Vehicles (PEVs) apply batteries with different capacities and control methods depending on their developers and suppliers. Therefore, there is an urgent need for a system capable of selective charging or discharging through control function capable of integrated management.

In addition, conventional technologies only provided unidirectional charging from the grid to the electric vehicle and did not provide discharging from the electric vehicle back to the grid. As a result, even when the electric vehicle is not operated for a long time and residual electric power remains, there is no way to manage the remaining battery electric power. This leftover electric power degrades battery life and causes unnecessary energy production costs.

### SUMMARY

### Technical Problem

The objective of the present invention is to provide a charging-and-discharging system for selectively performing charging or discharging of electric vehicles by charging-and-discharging voltage control, and a charging-and-discharging control method using the same.

### Technical Solution

A charging-and-discharging control method of a charging-and-discharging system including a processor for performing charging-and-discharging of a battery of an electric vehicle according to the technical concept of the present disclosure may include: receiving, by the processor, a discharging command; increasing, by the processor, a charging-and-discharging voltage to a first voltage corresponding to a voltage level of the battery; supplying, by the processor, a test current using a current cutoff circuit; closing, by the processor, a relay switch with the electric vehicle in response to a confirmation signal for the test current; and decreasing, by the processor, the charging-and-discharging voltage to a second voltage lower than the first voltage.

In one embodiment, the increasing the charging-and-discharging voltage to the first voltage may include: detecting whether the relay switch is open in response to the discharging command; and increasing the charging-and-discharging voltage to the first voltage if the relay switch is open.

In one embodiment, the decreasing the charging-and-discharging voltage to the second voltage lower than the first voltage may include: determining, for the current cutoff circuit, a discharging current limit value for discharging; decreasing the charging-and-discharging voltage to the second voltage; and receiving a discharging current corresponding to the discharging current value by a discharging current value continuously increases to the discharging current limit value.

In one embodiment, the determining, for the current cutoff circuit, the discharging current limit value for discharging may include: determining the discharging current limit value to a first current value; and increasing the discharging current limit value to a second current value higher than the first current value if the discharging current value reaches the first current value.

In one embodiment, the method may further include: receiving, by the processor, a charging command; increasing, by the processor, the charging-and-discharging voltage to the first voltage; supplying, by the processor, a test current using the current cutoff circuit; closing, by the processor, a relay switch with the battery in response to a confirmation signal for the test current received from the electric vehicle or a device corresponding to the electric vehicle; and increasing, by the processor, the charging-and-discharging voltage to a third voltage higher than the first voltage.

In one embodiment, the increasing the charging-and-discharging voltage to the third voltage higher than the first voltage may include: determining, for the current cutoff circuit, a charging current limit value for charging; increasing the charging-and-discharging voltage to the third voltage; and supplying a charging current corresponding to the charging current value by a charging current value continuously increases to the charging current limit value.

In one embodiment, the method may further include: closing, by the processor, a capacity switch between a first charging-and-discharging circuit and a second charging-and-discharging circuit in response to a first charging command corresponding to a third amount of electric power, the third amount of electric power being a sum of a first amount of electric power and a second amount of electric power; and supplying, by the processor, the third amount of electric power to the battery using the first charging-and-discharging circuit and the second charging-and-discharging circuit. The charging-and-discharging system may include the first charging-and-discharging circuit corresponding to the first amount of electric power and the second charging-and-discharging circuit corresponding to the second amount of electric power, the first charging-and-discharging circuit and the second charging-and-discharging circuit being connected in parallel.

In one embodiment, the method may further include: opening, by the processor, the capacity switch between the first charging-and-discharging circuit and the second charging-and-discharging circuit in response to a second charging command corresponding to the first amount of electric power; and supplying, by the processor, the first amount of electric power to the battery using the first charging-and-discharging circuit.

In one embodiment, the method may further include: closing, by the processor, a capacity switch between a first charging-and-discharging circuit and a second charging-and-discharging circuit in response to a first discharging command corresponding to a third amount of electric power, the third amount of electric power being a sum of a first amount of electric power and a second amount of electric power; and receiving, by the processor, the third amount of electric power from the battery using the first charging-and-discharging circuit and the second charging-and-discharging circuit. The charging-and-discharging system may include the first charging-and-discharging circuit corresponding to the first amount of electric power and the second charging-and-discharging circuit corresponding to the second amount of electric power, the first charging-and-discharging circuit and the second charging-and-discharging circuit being connected in parallel.

In one embodiment, the method may further include: opening, by the processor, the capacity switch between the first charging-and-discharging circuit and the second charging-and-discharging circuit in response to a second discharging command corresponding to the first amount of electric power; and receiving, by the processor, the first amount of electric power from the battery using the first charging-and-discharging circuit.

In one embodiment, the closing the capacity switch between the first charging-and-discharging circuit and the second charging-and-discharging circuit may include: determining the first charging-and-discharging circuit and the second charging-and-discharging circuit as operational circuits corresponding to the third amount of electric power based on production capacity information of each charging-and-discharging circuit; and closing the capacity switch between the first charging-and-discharging circuit and the second charging-and-discharging circuit.

In one embodiment, the decreasing the charging-and-discharging voltage to a second voltage lower than the first voltage may include: decreasing the charging-and-discharging voltage to the second voltage; and decreasing the charging-and-discharging voltage to a third voltage lower than the second voltage after a predetermined time has elapsed.

A charging-and-discharging system for performing charging-and-discharging of a battery of an electric vehicle according to one embodiment of the present disclosure may include: a controller configured to perform charging-and-discharging of the battery by controlling voltage of the charging-and-discharging system; a charging-and-discharging circuit configured to supply current to the battery or receive current from the battery by controlling charging-and-discharging voltage applied to the battery in response to a control signal from the controller; a current cutoff circuit configured to control current level supplied to the battery or received from the battery; and a relay switch configured to control electrical connection between the charging-and-discharging system and the battery. The controller, in response to a discharging command, may increase the charging-and-discharging voltage to a first voltage corresponding to voltage level of the battery by controlling the charging-and-discharging circuit unit; supply a test current by controlling the current cutoff circuit; close the relay switch in response to a confirmation signal for the test current received from the electric vehicle or a device corresponding to the electric vehicle; and decrease the charging-and-discharging voltage to a second voltage lower than the first voltage by controlling the charging-and-discharging circuit unit.

In one embodiment, the controller may, in response to the discharging command, detect whether the relay switch is open, and if the relay switch is open, increases the charging-and-discharging voltage to the first voltage by controlling the charging-and-discharging circuit unit.

In one embodiment, the controller may determine a discharging current limit value, and continuously increases a discharging current value to the discharging current limit value and receives a discharging current corresponding to the discharging current value.

In one embodiment, the controller may, in response to a charging command, increase the charging-and-discharging voltage to the first voltage by controlling the charging-and-discharging circuit unit; supply the test current by controlling the current cutoff circuit; close the relay switch in response to a confirmation signal for the test current; and increase the charging-and-discharging voltage to a third voltage higher than the first voltage by controlling the charging-and-discharging circuit unit.

In one embodiment, the charging-and-discharging circuit unit may include: a first charging-and-discharging circuit corresponding to a first amount of electric power; a second charging-and-discharging circuit connected in parallel with the first charging-and-discharging circuit and corresponding to a second amount of electric power; and a capacity switch configured to switch between the first charging-and-discharging circuit and the second charging-and-discharging circuit. The controller may close the capacity switch in response to a first discharging command corresponding to a third amount of electric power, the third amount of electric power being a sum of the first amount of electric power and the second amount of electric power, and receive the third amount of electric power from the battery using the first charging-and-discharging circuit and the second charging-and-discharging circuit.

In one embodiment, the controller may, in response to a second discharging command corresponding to the first amount of electric power, open the capacity switch and receive the first amount of electric power from the battery using the first charging-and-discharging circuit.

### Effect of Invention

According to the charging-and-discharging system and the charging-and-discharging control method using the same, based on the technical concept of the present invention, charging or discharging of an electric vehicle may be selectively performed by modifying the charging-and-discharging voltage control sequence. Accordingly, not only charging but also discharging of the electric vehicle may be performed through charging-and-discharging voltage control using a single charging-and-discharging device. Therefore, residual electric power in the electric vehicle may be recovered and utilized elsewhere, enabling electric power transfer using the electric vehicle, and aging of the battery due to residual electric power may be prevented.

### BRIEF DESCRIPTION OF THE DRAWINGS

FIG. 1 is a block diagram illustrating an operation of a charging-and-discharging system according to an exemplary embodiment of the present disclosure.

FIG. 2 is a block diagram illustrating a configuration of the charging-and-discharging system according to an exemplary embodiment of the present disclosure.

FIG. 3 is a block diagram illustrating a charging-and-discharging circuit according to an exemplary embodiment of the present disclosure.

FIG. 4 is a flowchart illustrating a charging-and-discharging control method according to an exemplary embodiment of the present disclosure.

FIG. 5 is a timing diagram illustrating the operation of the charging-and-discharging system according to an exemplary embodiment of the present disclosure.

FIG. 6 is a timing diagram illustrating an operation method of the charging-and-discharging system according to an exemplary embodiment of the present disclosure.

FIG. 7 is a flowchart illustrating a circuit selection process based on electric power request according to an exemplary embodiment of the present disclosure.

FIG. 8 is a block diagram illustrating a plurality of charging-and-discharging circuits according to an exemplary embodiment of the present disclosure.

FIG. 9 is a block diagram illustrating a computing system according to an exemplary embodiment of the present disclosure.

### DETAILED DESCRIPTION

Hereinafter, preferred embodiments of the present disclosure will be described in detail with reference to the accompanying drawings. Advantages and features of the present disclosure, and methods for achieving them, will be clarified through the embodiments described in detail below in conjunction with the accompanying drawings. However, the technical concept of the present disclosure is not limited to the following embodiments and may be implemented in various different forms. These embodiments are provided merely to ensure completeness of the technical concept of the present disclosure and to fully convey the scope of the present disclosure to those skilled in the art, and the technical concept of the present disclosure shall be defined only by the scope of the claims.

It should be noted that, in assigning reference numerals to the components of the drawings, the same numerals are used for the same components, even if they appear in different drawings, as much as possible.

In addition, when explaining the present disclosure, detailed descriptions of related known configurations or functions may be omitted if it is determined that such details may obscure the essence of the present disclosure.

Unless otherwise defined, all terms (including technical and scientific terms) used in this specification may be interpreted as having meanings commonly understood by those skilled in the art to which the present disclosure belongs. Terms defined in generally used dictionaries should not be interpreted ideally or overly unless clearly defined otherwise.

The terminology used herein is intended to describe embodiments for the purpose of explanation and is not intended to limit the present disclosure.

In this specification, singular forms also include plural forms unless explicitly stated otherwise.

Also, in describing the components of the present disclosure, terms such as first, second, A, B, (a), (b), etc. may be used. These terms are merely used to distinguish the respective components from one another and do not imply limitations on the nature, order, or sequence of the components. If a component is described as being “connected,” “coupled,” or “linked” to another component, it may be directly connected or linked to that component, or there may be another component interposed between them.

The terms “comprises” and/or “comprising” as used in the present disclosure do not exclude the presence or addition of one or more other components, steps, operations, and/or elements other than those stated.

A component included in one embodiment and a component with a common function may be described using the same name in another embodiment. Unless otherwise stated, the description given for one embodiment may apply to other embodiments as well, and specific descriptions may be omitted within the scope that is overlapping or clearly understandable to those skilled in the art.

Hereinafter, preferred embodiments of the present invention will be described in detail with reference to the accompanying drawings.

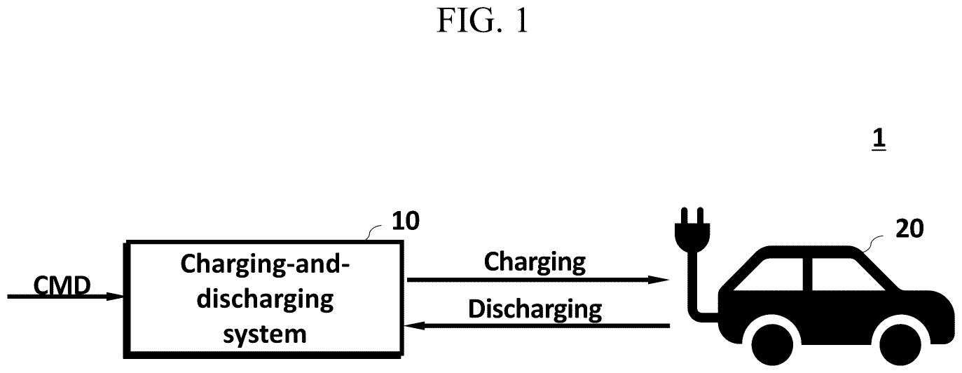

FIG. 1 is a block diagram illustrating an operation of a charging-and-discharging system according to an exemplary embodiment of the present disclosure.

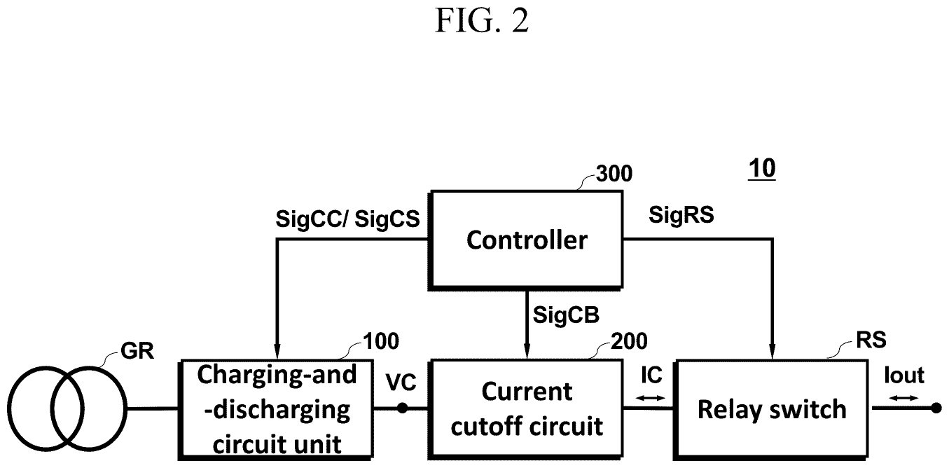

Referring to FIG. 1, a charging-and-discharging system 10 may be utilized to perform charging or discharging of an electric vehicle 20 using a single charging-and-discharging device. In one embodiment, the charging-and-discharging system 10 may be connected to a grid and may include a charging-and-discharging device that performs charging or discharging of the electric vehicle 20, and various terminals that control the charging-and-discharging device. These elements will be described in more detail with reference to FIG. 2.

The electric vehicle 20 may include various mobile objects electric powered by electric energy (e.g., automobiles, motorcycles, electric wheelchairs, drones, helicopters, robots), and to this end, the electric vehicle 20 may include a battery.

According to one embodiment of the present disclosure, the charging-and-discharging system 10 may selectively perform charging or discharging of the electric vehicle 20 based on a command CMD. For example, when the received command from a user is a charging command, the charging-and-discharging system 10 may supply electric power to the electric vehicle 20 using a charging-and-discharging voltage sequence corresponding to charging. If the command is a discharging command, the charging-and-discharging system 10 may receive electric power from the electric vehicle 20 using a charging-and-discharging voltage sequence corresponding to discharging.

Although the specification describes charging-and-discharging of the electric vehicle 20, the technical concept of the present disclosure is not limited thereto and may also be applied to the charging-and-discharging of all devices that include batteries.

FIG. 2 is a block diagram illustrating the charging-and-discharging system according to an exemplary embodiment of the present disclosure.

Referring to FIG. 2, the charging-and-discharging system 10 may include a charging-and-discharging circuit 100, a current cutoff circuit 200, a controller 300, and a relay switch RS.

The charging-and-discharging circuit 100, the current cutoff circuit 200, and the relay switch RS of the charging-and-discharging system 10 may be electrically connected to each other. The controller 300 may be connected to each of the charging-and-discharging circuit 100, the current cutoff circuit 200, and the relay switch RS to allow communication with them. In the case of wired connection, the controller 300 and each of the charging-and-discharging circuit 100, the current cutoff circuit 200, and the relay switch RS may communicate using a serial method. In the case of wireless connection, the controller 300 and each of the charging-and-discharging circuit 100, the current cutoff circuit 200, and the relay switch RS may communicate using a wireless communication network such as a Local Area Network (LAN), Wide Area Network (WAN), World Wide Web (WWW), wired/wireless data network, telephone network, wired/wireless TV network, 3G, 4G, 5G, 3GPP, 5GPP, LTE, WiMAX, Wi-Fi, Internet, PAN, RF, Bluetooth, NFC, satellite broadcasting network, analog broadcasting network, Digital Multimedia Broadcasting (DMB) network, and others without limitation.

Each component of the charging-and-discharging system 10 may be implemented as one or more hardware devices. In one example, the controller 300 may be configured as a single hardware device that also includes the charging-and-discharging circuit 100, the current cutoff circuit 200, and the relay switch RS.

In another example, the charging-and-discharging circuit 100, the current cutoff circuit 200, and the relay switch RS may constitute a single hardware device, while the controller 300 may be configured as a separate device independent of the other components. In such a case, the controller 300 may be implemented as a terminal operated by the user, including but not limited to: cellular phones, smartphones, laptops, personal computers (PCs), navigation devices, PCS, GSM, PDC, PHS, PDAs, IMT-2000, CDMA-2000, W-CDMA, Wibro terminals, smartpads, or tablet PCs.

The charging-and-discharging circuit 100 may be connected to a grid GR and may generate a charging-and-discharging voltage VC for supplying or receiving electric power to or from the electric vehicle 20 by performing AC-DC conversion, DC-DC conversion, and the like. In this specification, the grid GR may refer to a electric power network connected to an electricity producer.

In one example, the charging-and-discharging circuit 100 may control the charging-and-discharging voltage VC based on a control signal SigCC/SigCS from the controller 300 to supply electric power from the grid GR to the electric vehicle 20. In another example, the charging-and-discharging circuit 100 may control the charging-and-discharging voltage VC based on the control signal SigCC/SigCS from the controller 300 to receive electric power from the electric vehicle 20 to the grid GR or to an internal battery of the charging-and-discharging system 10.

The current cutoff circuit 200 may control the limit of the charging-and-discharging current IC flowing to the electric vehicle 20 such that it does not exceed a current threshold, based on the charging-and-discharging voltage VC. In one embodiment, the current cutoff circuit 200 may determine the current threshold based on a current cutoff signal SigCB from the controller 300.

The relay switch RS may electrically connect or disconnect the charging-and-discharging system 10 and the electric vehicle 20 to supply or receive output current Iout. In one example, the relay switch RS may close or open the path between the current cutoff circuit 200 and the electric vehicle 20 based on a switching control signal SigRS, thereby determining whether the output current Iout is supplied or received.

The controller 300 may generate various control signals to control the charging-and-discharging system 10. In this specification, the operations of the controller 300 may be understood as operations performed by a processor included in the controller 300 based on a computer program including at least one instruction stored in a storage device within the charging-and-discharging system 10. The storage device may include non-volatile memory, volatile memory, flash memory, HDD, or SSD. The processor may include at least one of a CPU, GPU, NPU, RAM, ROM, system bus, or application processor.

The controller 300 may output the control signal SigCC/SigCS to the charging-and-discharging circuit 100 based on the command CMD. In one embodiment, the controller 300 may output a voltage control signal SigCC to the charging-and-discharging circuit 100, and the charging-and-discharging circuit 100 may change the level of the charging-and-discharging voltage VC based on the voltage control signal SigCC. As the charging-and-discharging voltage VC changes, charging or discharging may be selectively performed.

According to the technical concept of the present disclosure, the charging-and-discharging system 10 may select charging or discharging using a single charging-and-discharging circuit simply by controlling the charging-and-discharging voltage VC of the charging-and-discharging circuit 100. Thus, charging or discharging of the electric vehicle 20 may be easily performed without using separate circuits for charging and discharging or changing the hardware configuration.

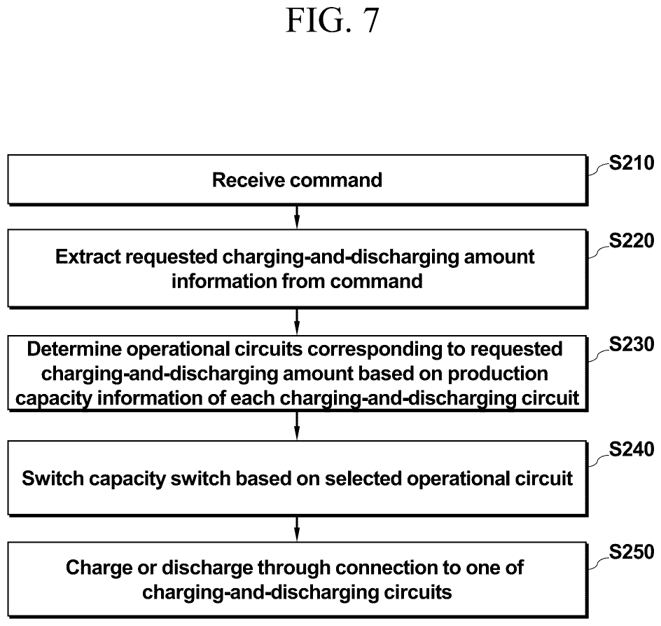

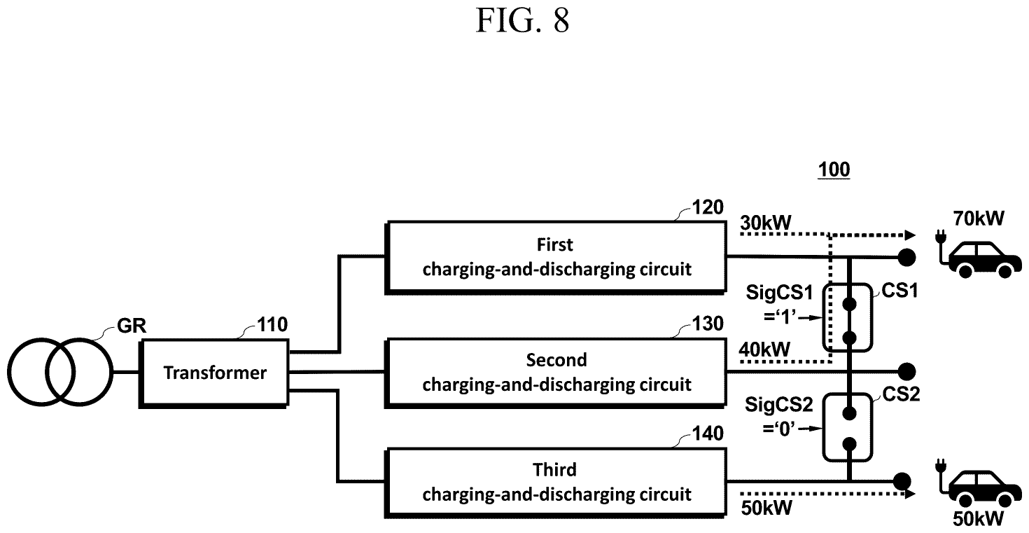

The controller 300 may output a capacity control signal SigCS to the charging-and-discharging circuit 100 based on the command CMD. The charging-and-discharging circuit 100 may switch between a plurality of charging-and-discharging circuits based on the capacity control signal SigCS to supply electric power from a plurality of circuits. Details will be described later with reference to FIGS. 7 and 8.

The controller 300 may output a current cutoff signal SigCB to the current cutoff circuit 200 based on the command CMD. In one embodiment, the current cutoff signal SigCB may include information on the current limit value, which is the threshold of the output current Iout, and the current cutoff circuit 200 may limit the charging-and-discharging current IC so that it does not exceed the current limit value. According to one embodiment of the present disclosure, the current cutoff circuit 200 may prevent the battery from being damaged by a sudden current or an accident caused by excessive current by ensuring that a current level of the charging-and-discharging current IC does not exceed the current limit value.

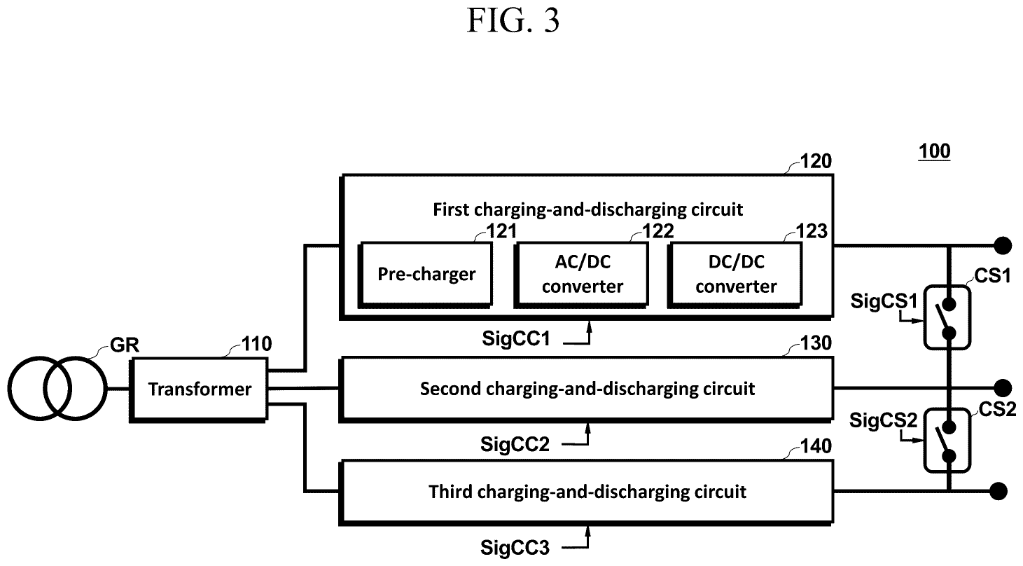

FIG. 3 is a block diagram illustrating the charging-and-discharging circuit unit according to an exemplary embodiment of the present disclosure.

Referring to FIG. 3, the charging-and-discharging circuit 100 may include a transformer 110, a first charging-and-discharging circuit 120, a second charging-and-discharging circuit 130, a third charging-and-discharging circuit 140, and capacity switches CS1 and CS2.

The transformer 110 may convert a voltage level of electric power supplied at a high voltage from the grid GR into a voltage level usable by the charging-and-discharging circuit 100. In one example, the transformer 110 may be implemented as an isolation transformer.

Each of the first charging-and-discharging circuit 120, the second charging-and-discharging circuit 130, and the third charging-and-discharging circuit 140 may represent a circuit configured to modulate electric power received from the transformer 110 to supply the electric power to the electric vehicle 20, or to modulate electric power received from the electric vehicle 20 so as to supply the electric power to the grid GR. The second and third charging-and-discharging circuits 130 and 140 may perform the same or similar operations as the first charging-and-discharging circuit 120, and therefore will not be described separately.

The first charging-and-discharging circuit 120 may include a pre-charger 121, an AC/DC converter 122, and a DC/DC converter 123. The pre-charger 121 may pre-charge the electric power received from the transformer 110 to a certain potential. The AC/DC converter 122 may convert the pre-charged electric power from AC to DC. The DC/DC converter 123 may generate a charging-and-discharging voltage VC by converting the DC voltage level based on a first voltage control signal SigCC1.

The capacity switches CS1 and CS2 may close or open the outputs between the charging-and-discharging circuits 120, 130, and 140 based on capacity control signals SigCS1, SigCS2. For example, the first capacity switch CS1 may close or open the output between the first charging-and-discharging circuit 120 and the second charging-and-discharging circuit 130 based on the first capacity control signal SigCS1, thereby allowing the user to supply the desired amount of electric power to the electric vehicle 20 through a single output node. This will be described in detail with reference to FIGS. 7 and 8.

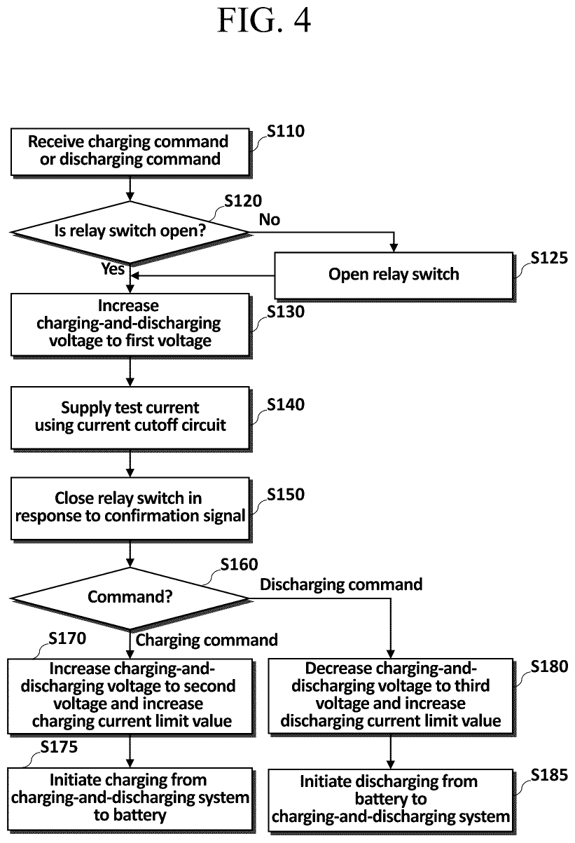

FIG. 4 illustrates a charging-and-discharging control method according to an exemplary embodiment of the present disclosure.

Referring to FIGS. 2 and 4, the controller 300 may receive a charging command or a discharging command, step S110, and detects whether the relay switch RS is open, step S120. If the relay switch RS is closed, the controller 300 may open the relay switch RS based on a switching control signal SigRS, step S125.

According to one embodiment of the present disclosure, by detecting whether the relay switch RS is open before the charging-and-discharging operation, malfunction or accident due to sudden voltage level change may be prevented, enabling efficient charging or discharging.

If the relay switch RS is open, the controller 300 may increase the charging-and-discharging voltage to a first voltage, step S130. In one example, the first voltage may be equal to the internal voltage level of the electric vehicle 20, and may either be predetermined depending on the charging-and-discharging target or input by the user.

The controller 300 may supply a test current to the electric vehicle 20 by controlling current limit value of the current cutoff circuit 200, step S140. In one example, the charging-and-discharging system 10 may supply the test current to the electric vehicle 20 through a connection separate from the relay switch RS. In one example, the system may transmit the test current to a device separate from the electric vehicle 20 and receive a confirmation signal from the device.

The controller 300 may receive a confirmation signal from the electric vehicle 20 in response to the test current, and close the relay switch RS accordingly, step S150. According to one embodiment, the test current is supplied first, and the relay is closed only after receiving a valid confirmation signal, thereby preventing unexpected accidents caused charging-and-discharging voltage VC at a high voltage and enabling stable charging-and-discharging.

The controller 300 may control the voltage level of the charging-and-discharging voltage VC differently depending on the type of command, step S160. If the command is a charging command, the controller 300 may increase the charging-and-discharging voltage VC to a second voltage higher than the first voltage and increase the current cutoff value of the current cutoff circuit to a charging current limit value, step S170. Since the charging-and-discharging voltage VC of the charging-and-discharging system 10 has a second voltage higher than a first voltage, which is a battery voltage of the electric vehicle 20, charging may be initiated from the charging-and-discharging system 10, which has a high voltage, to the battery of the electric vehicle 20, which has a low voltage, step S175.

If the command is a discharging command, the controller 300 may decrease the charging-and-discharging voltage VC to a third voltage below the first voltage and increase the current cutoff value of the current cutoff circuit to a discharging current limit value, step S180. Since the charging-and-discharging voltage VC of the charging-and-discharging system 10 has a third voltage lower than a first voltage, which is a battery voltage of the electric vehicle 20, discharging may be initiated from the battery of the electric vehicle 20, which has a high voltage, to the charging-and-discharging system 10, which has a low voltage, step S185.

According to one embodiment of the present disclosure, the controller 300 may control the voltage level to be lower or higher than the battery voltage level of the electric vehicle 20 depending on the type of command, and accordingly, charging or discharging may be selectively performed, thereby enabling stable charging and discharging using a single charging-and-discharging circuit. In addition, the controller 300 may use the current limit value to prevent from increasing to a level equal to or greater than a predetermined current value, thereby preventing accidents due to overload and enabling efficient charging-and-discharging.

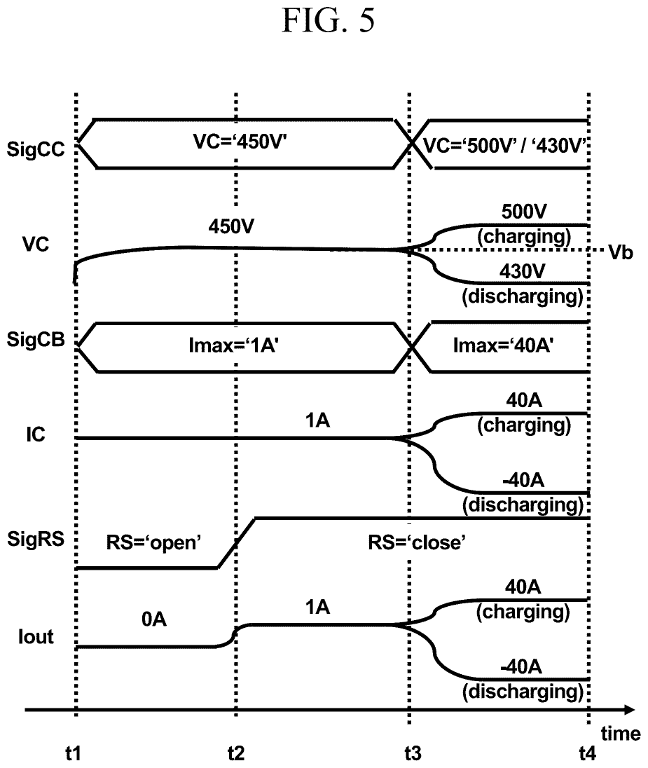

FIG. 5 is a timing diagram illustrating an operation of the charging-and-discharging system.

Referring to FIGS. 2 and 5, first time point t1 may represent the moment the system receives a command and detects that the relay switch RS is open (e.g., steps S110 to S125 of FIG. 4). The controller 300 may output, to the charging-and-discharging circuit unit 100, a voltage control signal SigCC to increase the charging-and-discharging voltage VC to a first voltage (e.g., 450V), which is equal to the battery voltage Vb of the electric vehicle 20. The charging-and-discharging circuit unit 100 may correspondingly increase the charging-and-discharging voltage VC to the first voltage (450V).

The controller 300 may also output, output a current cutoff signal SigCB, in which a current limit value Imax is set to ‘1 A’, to the current cutoff circuit 200, and the current cutoff circuit 200 may transmit 1 A as test current to the electric vehicle 20 or the corresponding device.

Additionally, the controller 300 may output ‘open’ (or ‘0’) as the switching control signal SigRS to the relay switch RS, and as the relay switch RS remains open, the output current Iout remains at ‘0 A’.

Second time point t2 may represent when the charging-and-discharging system receives a confirmation signal in response to the test current (e.g., step S150 of FIG. 4). The controller 300 may output ‘close’ (or ‘1’) as the switching control signal SigRS to close the relay switch RS in response to the confirmation signal, and the output current Iout may maintain the test current level of ‘1 A’.

Third time point t3 may represent when the charging-and-discharging system 10 confirms the command and controls the voltage accordingly (e.g., steps S170 and S180 of FIG. 4). If a charging command is received, the controller 300 may output a signal to increase the charging-and-discharging VC to a second voltage (e.g., 500V) higher than the battery voltage Vb, and the charging-and-discharging circuit 100 then may increase the charging-and-discharging VC to the second voltage (500V). The controller 300 may output, as a current cutoff signal SigCB, a signal that increases the charging current limit value Imax higher than the test current (e.g., 40 A) to the current cutoff circuit 200, and, as the relay switch RS is closed, an output current Iout of 40 A may be supplied from the charging-and-discharging system 10 to the battery of the electric vehicle 20, which has a voltage lower than the charging-and-discharging voltage VC.

If a discharging command is received, the controller 300 may output, to the charging-and-discharging circuit 100, a signal to decrease the charging-and-discharging voltage VC to a third voltage (e.g., 430V) lower than the battery voltage Vb. Accordingly, the charging-and-discharging circuit 100 may decrease the charging-and-discharging VC to the third voltage (430V). Additionally, the controller 300 may output, as a current cutoff signal SigCB, a signal that increases the charging current limit value Imax to a level higher than the test current (e.g., 40 A) to the current cutoff circuit 200, and, as the relay switch RS is closed, an output current Iout of 40 A may be supplied from the battery of the electric vehicle 20, which has a voltage higher than the charging-and-discharging voltage VC, to the charging-and-discharging system 10.

According to the technical concept of the present disclosure, charging or discharging of the battery may be determined by controlling the charging-and-discharging voltage, and at the same time, by controlling the amount of current using the current limit value, selective charging and discharging using a single device may be enabled without accidents caused by overload.

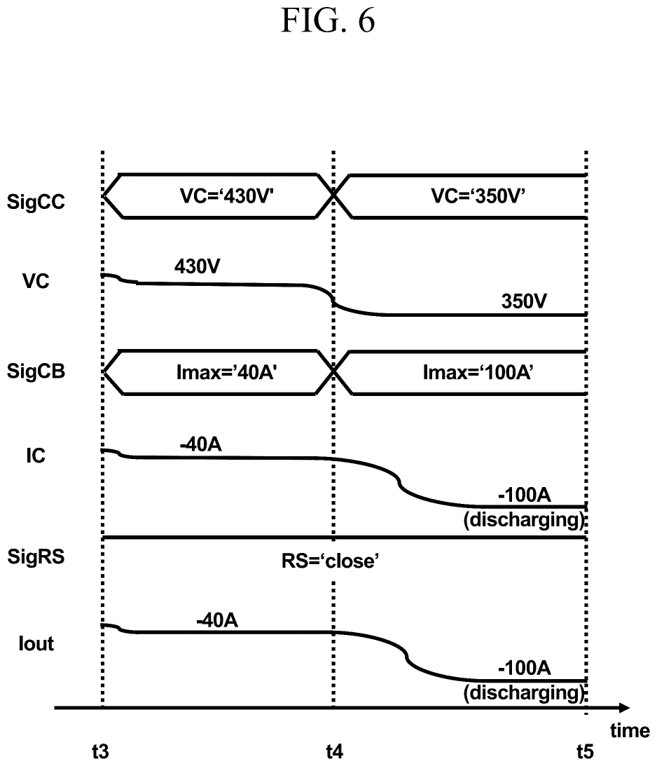

FIG. 6 is a timing diagram illustrating an operation method of the charging-and-discharging system according to an exemplary embodiment of the present disclosure. More specifically, FIG. 6 depicts the process after the third time point t3 in FIG. 5, for a case where the discharging command is received. Repetitive content with FIG. 5 is omitted.

Referring to FIG. 6, the controller 300 may decrease the voltage in two steps in response to the discharging command. Similarly, the controller 300 may control the current limit value in two steps in response to the discharging command.

At fourth time point t4, which occurs a predetermined time after the third time point t3, the controller 300 may output, to the charging-and-discharging circuit 100, a voltage control signal SigCC to decrease the charging-and-discharging voltage VC to a fourth voltage (e.g., 350V) which is lower than the third voltage (430V), and the charging-and-discharging circuit 100 may accordingly decrease the charging-and-discharging voltage VC to the fourth voltage (350V). As a result, the voltage gap between the charging-and-discharging system 10 and the battery of the electric vehicle 20 may become even wider.

At the same time, the controller 300 may output, to the current cutoff circuit 200, a current cutoff signal SigCB to increase the current limit value Imax above the previous current value (e.g., 40 A), and the output current Iout may rise to higher level (e.g., 100 A). This allows the charging-and-discharging system to receive higher level of current from the battery of the electric vehicle 20.

According to one embodiment of the present disclosure, gradually increasing or decreasing the charging-and-discharging voltage VC and output current Iout may help prevent accidents caused by sudden changes of the voltage/current level, while improving the charging-and-discharging speed. Thus, fast and safe charging-and-discharging may become possible.

Although FIG. 6 shows only an example of discharging, the same technical concept is clearly applicable to charging as well. Also, while FIG. 6 illustrates a two-step control process for voltage/current levels, the concept can naturally be extended to implementations with more than two steps.

FIG. 7 is a flowchart illustrating a charging-and-discharging control method according to an exemplary embodiment of the present disclosure.

Referring to FIG. 7, the controller receives a command, step S210, and may extract requested charging-and-discharging amount information from the command, step S220. In this specification, the requested charging-and-discharging amount information may refer to the amount of electric power the user desires to charge into or discharge from the electric vehicle etc.

The controller 300 may determine operational circuits corresponding to the requested charging-and-discharging amount based on production capacity information of each charging-and-discharging circuit, step S230. According to one embodiment, each circuit may have different electric power production capabilities, and the controller 300 may select a suitable operational circuits from among a plurality of circuits based on the requested charging-and-discharging amount.

The controller 300 may switch a capacity switch CS based on the selected operational circuits, step S240, and may perform charging or discharging by connecting the battery of the electric vehicle 20 to one of the charging-and-discharging circuits corresponding to the operational circuits, step S250.

According to one embodiment, efficient charging-and-discharging may be achieved by supplying or receiving electric power through the connection of charging-and-discharging circuits corresponding to the desired amount of electric power, using the plurality of the charging-and-discharging circuits having different electric power generation capacities. This enables the user to supply or receive the desired amount of electric power at the precise time without spending a long period of time.

FIG. 8 is a block diagram illustrating the charging-and-discharging system according to an exemplary embodiment of the present disclosure.

In the example of FIG. 8, a first charging-and-discharging circuit 120 may supply or receive 30 kW per unit time, a second charging-and-discharging circuit may supply or receive 40 kW per unit time, and a third charging-and-discharging circuit may supply or receive 50 kW per unit time.

If the user requests 70 kW as the requested charging-and-discharging amount, the controller 300 may determine the first charging-and-discharging circuit 120 and the second charging-and-discharging circuit 130 as operational circuits based on each circuit's production capacity. Using switching control signals SigSC1 and SigSC2, the controller 300 may close the first capacity switch CS1 and open the second capacity switch CS2. As a result, by using a node connected to the first charging-and-discharging circuit 120, the user may receive 30 kW from the first charging-and-discharging circuit 120 and 40 kW from the second charging-and-discharging circuit 130, thereby receiving 70 kW in total per unit time.

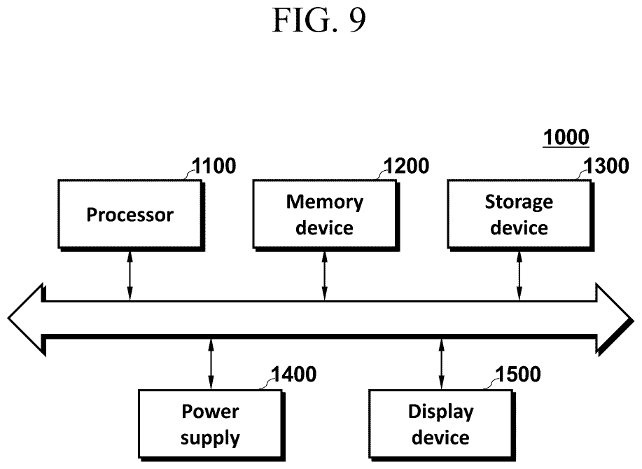

FIG. 9 is a block diagram illustrating a computing system according to an exemplary embodiment of the present disclosure.

Referring to FIG. 9, the computing system 1000 may constitute charging-and-discharging system 10 and may include a processor 1100, memory device 1200, storage device 1300, electric power supply 1400, and display device 1500. Although not shown in FIG. 9, the computing system 1000 may further include ports for communicating with devices such as video cards, sound cards, memory cards, USB devices, or other electronic equipment.

As such, the processor 1100, the memory device 1200, the storage device 1300, the electric power supply 1400, and the display device 1500 included in the computing system 1000 may constitute the controller 300 that performs the charging-and-discharging control method according to embodiments of the present invention. Specifically, the processor 1100 may control the memory device 1200, storage device 1300, electric power supply 1400, and display device 1500 to perform the charging-and-discharging control methods described in FIGS. 1 to 8.

The processor 1100 may perform specific calculations or tasks. In some embodiments, the processor 1100 may be a microprocessor or CPU. It may communicate with the memory device 1200, storage device 1300, and display device 1500 via buses such as an address bus, control bus, and data bus. It may also be connected to expansion buses such as a PCI bus.

The memory device 1200 may store data required for the operation of the computing system 1000. For example, the memory device 1200 may be implemented as DRAM, mobile DRAM, SRAM, PRAM, FRAM, RRAM, and/or MRAM. The storage device 1300 may include SSDs, HDDs, or CD-ROMs. The storage device 1300 may store programs, application data, system data, and OS data related to the control methods described in FIGS. 1 to 8.

The display device 1500 may serve as an output unit to notify the user by presenting information about the charging-and-discharging control method. The electric power supply 1400 may provide the necessary operating voltage for the computing system 1000.

As described above, exemplary embodiments have been disclosed in the drawings and specification. Specific terminology has been used to describe the embodiments, but this is for illustrative purposes only and is not intended to limit the scope of the present disclosure as defined by the claims. Those skilled in the art will understand that various modifications and equivalent embodiments are possible. Therefore, the true scope of protection for the present disclosure should be defined by the technical spirit set forth in the appended claims.

What is claimed is:

1. A charging-and-discharging control method of a charging-and-discharging system including a processor for performing charging-and-discharging of a battery of an electric vehicle, the method comprising
receiving, by the processor, a discharging command;
increasing, by the processor, a charging-and-discharging voltage to a first voltage corresponding to a voltage level of the battery;
supplying, by the processor, a test current using a current cutoff circuit;
closing, by the processor, a relay switch with the electric vehicle in response to a confirmation signal for the test current; and
decreasing, by the processor, the charging-and-discharging voltage to a second voltage lower than the first voltage.

2. The method of claim 1,
wherein the increasing the charging-and-discharging voltage to the first voltage comprises:
detecting whether the relay switch is open in response to the discharging command; and
increasing the charging-and-discharging voltage to the first voltage if the relay switch is open.

3. The method of claim 1,
wherein the decreasing the charging-and-discharging voltage to the second voltage lower than the first voltage comprises:
determining, for the current cutoff circuit, a discharging current limit value for discharging;
decreasing the charging-and-discharging voltage to the second voltage; and
receiving a discharging current corresponding to the discharging current value by a discharging current value continuously increases to the discharging current limit value.

4. The method of claim 3,
wherein the determining, for the current cutoff circuit, the discharging current limit value for discharging comprises:
determining the discharging current limit value to a first current value; and
increasing the discharging current limit value to a second current value higher than the first current value if the discharging current value reaches the first current value.

5. The method of claim 1, further comprising:
receiving, by the processor, a charging command;
increasing, by the processor, the charging-and-discharging voltage to the first voltage;
supplying, by the processor, a test current using the current cutoff circuit;
closing, by the processor, a relay switch with the battery in response to a confirmation signal for the test current received from the electric vehicle or a device corresponding to the electric vehicle; and
increasing, by the processor, the charging-and-discharging voltage to a third voltage higher than the first voltage.

6. The method of claim 5,
wherein the increasing the charging-and-discharging voltage to the third voltage higher than the first voltage comprises:
determining, for the current cutoff circuit, a charging current limit value for charging;
increasing the charging-and-discharging voltage to the third voltage; and
supplying a charging current corresponding to the charging current value by a charging current value continuously increases to the charging current limit value.

7. The method of claim 1, further comprising:
closing, by the processor, a capacity switch between a first charging-and-discharging circuit and a second charging-and-discharging circuit in response to a first charging command corresponding to a third amount of electric power, the third amount of electric power being a sum of a first amount of electric power and a second amount of electric power; and
supplying, by the processor, the third amount of electric power to the battery using the first charging-and-discharging circuit and the second charging-and-discharging circuit,
wherein the charging-and-discharging system comprises the first charging-and-discharging circuit corresponding to the first amount of electric power and the second charging-and-discharging circuit corresponding to the second amount of electric power, the first charging-and-discharging circuit and the second charging-and-discharging circuit being connected in parallel.

8. The method of claim 7, further comprising:
opening, by the processor, the capacity switch between the first charging-and-discharging circuit and the second charging-and-discharging circuit in response to a second charging command corresponding to the first amount of electric power; and
supplying, by the processor, the first amount of electric power to the battery using the first charging-and-discharging circuit.

9. The method of claim 1, further comprising:
closing, by the processor, a capacity switch between a first charging-and-discharging circuit and a second charging-and-discharging circuit in response to a first discharging command corresponding to a third amount of electric power, the third amount of electric power being a sum of a first amount of electric power and a second amount of electric power; and
receiving, by the processor, the third amount of electric power from the battery using the first charging-and-discharging circuit and the second charging-and-discharging circuit,
wherein the charging-and-discharging system comprises the first charging-and-discharging circuit corresponding to the first amount of electric power and the second charging-and-discharging circuit corresponding to the second amount of electric power, the first charging-and-discharging circuit and the second charging-and-discharging circuit being connected in parallel.

10. The method of claim 9, further comprising:
opening, by the processor, the capacity switch between the first charging-and-discharging circuit and the second charging-and-discharging circuit in response to a second discharging command corresponding to the first amount of electric power; and
receiving, by the processor, the first amount of electric power from the battery using the first charging-and-discharging circuit.

11. The method of claim 9,
wherein the closing the capacity switch between the first charging-and-discharging circuit and the second charging-and-discharging circuit comprises:
determining the first charging-and-discharging circuit and the second charging-and-discharging circuit as operational circuits corresponding to the third amount of electric power based on production capacity information of each charging-and-discharging circuit; and
closing the capacity switch between the first charging-and-discharging circuit and the second charging-and-discharging circuit.

12. The method of claim 1,
wherein the decreasing the charging-and-discharging voltage to a second voltage lower than the first voltage comprises:
decreasing the charging-and-discharging voltage to the second voltage; and
decreasing the charging-and-discharging voltage to a third voltage lower than the second voltage after a predetermined time has elapsed.

13. A charging-and-discharging system for performing charging-and-discharging of a battery of an electric vehicle, the system comprising:
a controller configured to perform charging-and-discharging of the battery by controlling voltage of the charging-and-discharging system;
a charging-and-discharging circuit configured to supply current to the battery or receive current from the battery by controlling charging-and-discharging voltage applied to the battery in response to a control signal from the controller;
a current cutoff circuit configured to control current level supplied to the battery or received from the battery; and
a relay switch configured to control electrical connection between the charging-and-discharging system and the battery,
wherein the controller, in response to a discharging command:
increases the charging-and-discharging voltage to a first voltage corresponding to voltage level of the battery by controlling the charging-and-discharging circuit unit;
supplies a test current by controlling the current cutoff circuit;
closes the relay switch in response to a confirmation signal for the test current received from the electric vehicle or a device corresponding to the electric vehicle; and
decreases the charging-and-discharging voltage to a second voltage lower than the first voltage by controlling the charging-and-discharging circuit unit.

14. The system of claim 13,
wherein the controller, in response to the discharging command, detects whether the relay switch is open, and if the relay switch is open, increases the charging-and-discharging voltage to the first voltage by controlling the charging-and-discharging circuit unit.

15. The system of claim 13,
wherein the controller determines a discharging current limit value, and continuously increases a discharging current value to the discharging current limit value and receives a discharging current corresponding to the discharging current value.

16. The system of claim 13,
wherein the controller, in response to a charging command:
increases the charging-and-discharging voltage to the first voltage by controlling the charging-and-discharging circuit unit;
supplies the test current by controlling the current cutoff circuit;
closes the relay switch in response to a confirmation signal for the test current; and
increases the charging-and-discharging voltage to a third voltage higher than the first voltage by controlling the charging-and-discharging circuit unit.

17. The system of claim 13,
wherein the charging-and-discharging circuit unit comprises:
a first charging-and-discharging circuit corresponding to a first amount of electric power;
a second charging-and-discharging circuit connected in parallel with the first charging-and-discharging circuit and corresponding to a second amount of electric power; and
a capacity switch configured to switch between the first charging-and-discharging circuit and the second charging-and-discharging circuit,
wherein the controller closes the capacity switch in response to a first discharging command corresponding to a third amount of electric power, the third amount of electric power being a sum of the first amount of electric power and the second amount of electric power, and receives the third amount of electric power from the battery using the first charging-and-discharging circuit and the second charging-and-discharging circuit.

18. The system of claim 17,
wherein the controller, in response to a second discharging command corresponding to the first amount of electric power, opens the capacity switch and receives the first amount of electric power from the battery using the first charging-and-discharging circuit.
